(19) United States
(12) Patent Application Publication
(10) Pub. No.: US 2024/0407580 A1
(43) Pub. Date: Dec. 12, 2024

(54) Electronic Mailbox

(71) Applicant: Blanca María Cortés García-Sacedón, MECO (Madrid) (ES)

(72) Inventor: Blanca María Cortés García-Sacedón, MECO (Madrid) (ES)

(21) Appl. No.: 18/700,762

(22) PCT Filed: Jan. 27, 2022
(86) PCT No.: PCT/EP2022/051881

§ 371 Date: Apr. 12, 2024

(30) Foreign Application Priority Data
Oct. 13, 2021 (ES) P202130961

(51) Int. Cl. A47G 29/12; A47G 29/122

(52) U.S. Cl. CPC A47G 29/1214; A47G 29/1216; A47G 2029/1226

(57) ABSTRACT

The present invention consists of an electronic mailbox specially adapted for receiving parcels transported or delivered by an aerial vehicle. Said mailbox includes a rigid structure as well as an internal cavity wherein the parcel can be housed, which is accessible through a first door. For the appropriate delivery of said parcel from the aerial vehicle to the internal cavity, the mailbox includes a visual recognition and identification code, which enables the vehicle to identify it, as well as electronic opening and closing means of the first door.

The operation of the electronic mailbox is determined by an electronic control processor, comprised in said mailbox, connected to a communication module including a wireless signal receiver, and a geolocation device configured to detect the location of the mailbox.

### CROSS-REFERENCE TO RELATED APPLICATIONS

This application is the United States national phase of International Patent Application No. PCT/EP2022/051881 filed Jan. 27, 2022, and claims priority to Spanish Patent Application No. P202130961 filed Oct. 13, 2021, the disclosures of which are hereby incorporated by reference in their entireties.

### BACKGROUND OF THE INVENTION

### Field of the Invention

The object of the present invention is to provide an electronic mailbox for receiving and delivering parcels that can work autonomously and automatically, for receiving parcels from an also autonomous means and store them until they are collected by a user.

Another object of the invention consists of a system for delivering and collecting parcels comprising the mailbox, as well as an aerial vehicle that can interact with said mailbox, and a method for delivering parcels between said mailbox and aerial vehicle.

The invention therefore falls within the sector of temporary storage of products and more specifically within the sector of automatic receptacles for mail, as well as within the sector of autonomous transport of said products.

### Description of Related Art

Today, the services sector is faced with the ongoing challenge of meeting the increasingly demanding needs of the population, one of said needs being the supply of products, with a reduced delivery time, in very specific places, and as close as possible to the places where they are, in order to avoid or reduce the collection time.

For this, many technologies aimed at reducing production, storage, management and delivery times have been developed in recent times, thereby generating additional collapse problems in the usual transport system that are not prepared for said changes, generating drawbacks and delays that directly harm the user in general.

One of the most recent technologies used that has been proposed for the dispatch of elements is that which uses autonomous aerial vehicles, known as “drones”, which are able to fly without requiring a pilot, following a previously established route, transporting with them a product of limited weight and size.

In theory, this novel technology enables a greater dispatch efficiency, greater reliability and shorter delivery time of the product, resulting in cost reduction and ultimately achieving a more competitive product.

In addition, this type of vehicle provides a solution to the problems that many sectors have in relation to the immediate shipping of products, as well as providing locations that are hard to access using the usual transport means.

This process is also a very good alternative to take care of the environment since “drones” do not emit polluting gases, as usual transport means do, most of them being propelled by electrical energy.

However, one of the biggest drawbacks of this dispatch system is the collection of said parcels, in many cases requiring iteration with a user, to prevent the product from being exposed to third parties.

Some dispatch systems with “drones” comprise a technology configured so that the “drone” delivers the parcel only when the user is available, which causes the greatest number of trips to be concentrated in specific hours of the day, making it impossible to use other time slots, and wasting useful delivery time.

For this reason, the need arises for a technology that is capable of interacting with this type of autonomous vehicles, and capable of retaining a product safely, for a limited time, until it can be collected by a user, without requiring that the user travels long distances from their usual location.

### SUMMARY OF THE INVENTION

The present invention consists of an electronic mailbox for receiving parcels comprising a rigid structure wherein said mailbox comprises:
a visual recognition and identification code of the electronic mailbox;
an internal cavity for storing parcels;
a first door of the internal cavity, configured to open and close, by means of electronic opening and closing means;
a communication module comprising a signal receiver, configured to receive wireless signals;
a geolocation device configured to detect the location of the mailbox; and
an electronic control processor connected to the opening and closing means of the first door and to the communication module.

Said control processor is configured to activate the electronic opening means of the first door when the signal receiver receives an activation signal.

The size and shape of the rigid structure is not limited to a specific range, being able to be larger or smaller depending on the needs of the user, as well as the place of installation. However, in a preferred embodiment, the mailbox has a standard size of 1 metre long, 0.5 metres wide by 0.5 metres tall, comprising a rectangular prismatic shape, so that said measurements are adapted to the most common requirements for storing parcels and to the available spaces, such as a locker.

In one embodiment, the visual code is a code selected from a barcode, a BIDI code, an alphanumeric code, and a combination of the above. Said visual code must be located in a position visible from a greater height with respect to said electronic mailbox, so that it can be captured, for example, by capture means, such as a camera, located at a greater height of the mailbox, at a specific distance.

The internal cavity of the mailbox enables the parcel to be retained for a required time, until it can be collected, so it must have a suitable size and shape for said use. Being internal means that it is usually located inside the rigid structure, especially when the parcel is delivered.

To avoid unauthorised access to the parcel when it is located inside the internal cavity, the mailbox has a first door, which can be automatically opened and closed, by means of the automatic opening and closing means that comprise at least one linear actuator and/or electromagnets. These means do not require a user for the internal cavity to be accessible or not, and they are compatible with different forms of opening, such as longitudinally or transversely sliding the cover with respect to the rigid structure, rotating it by means of a hinge, or combining both movements.

Preferably, the first door of the internal cavity is located on an upper surface of the electronic mailbox, so that the opening of the internal cavity, when the first door is open, is on said surface, preferably horizontal. In this way, a product can be introduced into the internal cavity, taking advantage of the effect of gravity, releasing it from a greater height.

Since, preferably, outdoor access to the mailbox can be provided, it is possible that the rigid structure and the first door are exposed to external, weather or wear effects; therefore, in one embodiment, said components are protected with an antioxidant coating that increases the useful life of the product.

In one embodiment, the signal receiver is configured to receive wireless signals selected from laser, radio frequency, Bluetooth, WIFI signals, and a combination of the above, so that an emitter of an external device can emit a signal that is captured by said receiver, which commands the opening of the first door, and that the internal cavity be accessible.

In one embodiment, the mailbox comprises at least one power generating, preferably photovoltaic, solar panel, fixed to the rigid structure of the mailbox, wherein said panel, or panels, are configured to electrically power the electronic mailbox, being able to store part or all of the electrical energy captured in batteries, also comprised in the mailbox, or transfer it to the grid. Specifically, said panels are configured to supply electrical energy to the components that require electricity to operate, such as the opening and closing means, the communication module, as well as other unmentioned elements that may be present in the mailbox, such as illumination means or other electronic elements.

These electrical components can operate with a voltage of 380 V in three-phase AC or 220 V in single-phase AC and, in addition to being able to be connected to solar panels comprised in the mailbox, they can also be connected to the electrical grid, so that the power supply is guaranteed when the solar panel is not working, or when the battery is empty.

In the same way, the electronic mailbox can also be connected, in addition to, or instead of, to said panels, to wind turbines located in the vicinity of the mailbox, to avoid consuming electricity from the grid in periods of solar energy scarcity.

In one embodiment, the communication module comprises a signal emitter configured to emit wireless signals, selected from laser, radio frequency, Bluetooth, WIFI signals, and a combination of the above. This signal emitter would be connected to the control processor and would enable the mailbox to connect to an electronic device of a user in order to inform about the collection or delivery of a parcel. In other words, in this embodiment, the mailbox not only receives signals, but can also emit them, in order to report on its status.

In one embodiment, the geolocation device comprises a location system using RTK technology. This Real-Time Kinematic or RTK technology is an advanced satellite positioning system that uses a ground station as a secondary position reference to provide accurate data to within one centimetre.

In this way, the RTK signal is obtained from a base antenna or antenna array with known coordinates, which can be placed in the mailbox, and can send a corrected signal to a vehicle receiver through radio systems. In this way, a vehicle receiver can receive a satellite signal and that of the RTK antenna, thus giving it centimetre accuracy.

This technology is especially suitable for the mailbox to interact with autonomous vehicles, such as aerial vehicles or “drones”, so that they can deposit the parcels in the internal cavity with high accuracy, without the need for a user to control said vehicle.

In one embodiment, the rigid structure of the mailbox is fixed, said rigid structure being rigidly attached to an external support. This external support can be the facade and/or the roof of a building, as well as a floor or a stable structure of another type of structural element. Since the rigid structure is attached, with a rigid attachment, to the external support, it cannot be moved from the position in which it has been installed, said position being preferably at a certain height with respect to the possible access by an unauthorised user, and without elements of the surroundings that could impair the movement of a “drone” when approaching or moving away from the mailbox.

In this embodiment, it is necessary that both the vehicle that delivers the parcel and the user who receives it have easy access to the internal cavity of the mailbox.

In a different embodiment, the rigid structure of the mailbox is moveable; and the mailbox comprises movement means connected to said rigid structure, wherein said means are configured to physically move the rigid structure upon being activated.

Preferably, said means only enable the rigid structure to be moved between two positions; a parcel reception position with respect to the aerial vehicle, also called the initial delivery position, and a user delivery position, also called the final delivery position. In this way, in the initial delivery position, the user may not have easy access to the rigid structure, but an aerial vehicle can more easily deliver a parcel, this position being able to be, for example, on the rooftop of a building. In the same way, in the final delivery position, it is easier for the user to access the rigid structure where the internal cavity with the parcel is located, but it is more difficult to access by an aerial vehicle, this position being able to be, for example, on the facade of a building, next to a hole like a window.

In one embodiment, the mailbox comprises a moveable frame comprising the internal cavity of the mailbox, and movement means connected to said moveable frame, wherein said means are configured to physically move the moveable frame with respect to the rigid and fixed structure of the mailbox upon being activated.

Preferably, the moveable frame is configured to be extracted and inserted into an interior of the rigid, fixed structure, through a second door.

Thus, in this embodiment, the mailbox comprises at least two openings, a first and a second door, the first preferably being on an upper surface, leaving a horizontal opening, and the second door on a lateral surface.

Preferably, the movement means of the frame would operate just as the movement means of the entire structure, i.e., moving the frame between two positions, the initial delivery and final delivery positions.

By means of this embodiment, it is not necessary to move the entire rigid structure, with all the components that it may have, it being sufficient that only the internal cavity located in the frame be moved, said movement being performed when the user requests it, sending a signal to the signal receiver of the mailbox, by means of an emitting device.

In one embodiment, the movement means comprise at least one rail and rolling elements, connected to the internal cavity, moveable along said rail, such that said elements can be connected to the rigid structure or to the frame, depending on the element that is moved, according to the embodiment.

Preferably, the rail or rails are configured to be fixed to the facade of a building, and the rolling elements comprise a plurality of wheels that can be coupled to said rail or rails, such that only the movement between the end positions of the rail is enabled.

In the event that the rail is installed on a rooftop and facade of a building, said rail may have different branches to be able to connect to the different holes in said building.

In one embodiment, the electronic control processor is configured to activate the movement means when the signal receiver receives an activation signal of said means. In this way, when the user sends a wireless signal by means of an electronic device, and it is received by the signal receiver, the movement means can move the internal cavity to the final delivery point, making it easier for said user to access the parcel.

In one embodiment, the movement means are configured to move the internal cavity of the mailbox along a facade of a building.

In one embodiment, the mailbox comprises a plurality of individual internal cavities for storing parcels; wherein each cavity comprises a third door for individual access to said internal cavity.

Preferably all the individual third doors are on a front or forward portion of the electronic mailbox, while the first door is on an upper surface.

The operation of this embodiment is similar to that of a set of lockers, so that each third door can only access the corresponding internal cavity, all cavities being aligned and connected.

In one embodiment, the mailbox comprises a single first door for the plurality of internal cavities comprised in said mailbox. Furthermore, the plurality of internal cavities is communicated by a movement system configured to move parcels between said cavity of the plurality of individual cavities.

In this way, an aerial vehicle can deposit a parcel through the first door and the movement system can place it in a specific internal cavity to be collected by a user, thus multiplying the storage capacity of the mailbox. Said movement system can comprise a series of conveyor belts, rollers, or lifts, as well as any usual element for this type of system.

To make it easy to use, the electronic control processor can inform the user about the location of the parcel to be collected by sending a wireless signal, and/or the mailbox can have a control screen that enables the user to view, access and control said mailbox.

Another portion of the invention consists of a system for collecting and shipping parcels, comprising at least one autonomous aerial vehicle for delivering and collecting parcels, such as a “drone” and an electronic mailbox as defined in any of the preceding embodiments.

In one embodiment of the system, the aerial vehicle comprises means for depositing and collecting a parcel from a surface of an internal cavity of the mailbox; and it is configured to move said parcel from a dispatch reception position to an initial delivery position.

In this way, the “drone” can have support and grip elements for the parcel and can be configured to search for the position of the electronic mailbox using RTK with the indicated technology, in the same way that it can have a location system or small radio beacon, to locate it in the event of impact or fall.

Another portion of the invention consists of a method for delivering parcels comprising the steps of:
moving a parcel, by means of a flying vehicle, such as a “drone”, from a dispatch reception position to an initial delivery position; and
depositing the parcel, by means of the flying vehicle, in an internal cavity of a mailbox as defined in any of the embodiments described above, said mailbox being located in the initial delivery position.

In one embodiment of the method for delivering parcels, the step of moving a parcel comprises the steps of:
locating the initial delivery position of the mailbox, by means of the aerial vehicle, using an RTK geolocation system;
reading, by means of an image capturing device comprised in the aerial vehicle, the visual recognition and identification code of the mailbox, said code being located on a surface visible from a position of a greater height of said mailbox;
sending a wireless signal, by means of a signal emitter located in the aerial vehicle, to the signal receiver of the communication module of the mailbox, for activating the electronic opening and closing means of the first door;
opening the first door of the internal cavity by means of the electronic opening and closing means.

In one embodiment of the method for delivering parcels, said method comprises the steps of:
automatically closing the first door of the internal cavity by means of the electronic opening and closing means; and
sending a wireless signal of parcel deposition in the internal cavity, by means of a signal emitter located in a communication module of the mailbox, to a
receiving device of an electronic device;
   wherein said steps are subsequent to the step of depositing the parcel, by means of the flying vehicle, in the internal cavity.

The automatic closing of the first door can be scheduled at a specific time after said first door has been opened, or after the parcel has been placed in the internal cavity, although it can also be performed when the signal receiver of the mailbox receives a closing signal by means of the aerial vehicle.

In one embodiment of the method for delivering parcels, said method comprises the steps of:
moving the internal cavity of the mailbox wherein the parcel is located, by means of the movement means, from the initial parcel delivery position to a final delivery position;
collecting the parcel, by means of a user, from the internal cavity of the mailbox, in the final delivery position; and
moving the internal cavity of the mailbox, by means of the movement means, from the final parcel delivery position to an initial delivery position.

Moving the internal cavity can entail moving the entire rigid structure of the mailbox or just moving a moveable frame.

In one embodiment of the method for delivering parcels, said method comprises the steps of:
moving the parcel deposited in an internal cavity of the mailbox, to another internal cavity of the plurality of internal cavities comprised in the same mailbox, by means of the movement system;
   collecting the parcel, by means of a user, from the internal cavity of the mailbox that houses the parcel, by opening the third door for individual access to said internal cavity.

With this embodiment, the embodiment wherein the mailbox comprises a plurality of third doors and internal cavities is required.

With regard to the embodiments of the methods for delivering parcels, it should be mentioned that the parcel can go the other way, i.e., from the user to the aerial vehicle, for example, when a return is to be made.

Thus, it may comprise the steps of depositing the parcel by means of a user to be collected by an aerial vehicle.

The aerial vehicles or “drones” that can be used in the defined system and method can have a series of features that make them suitable for said use. For example, preferably, they must have autonomous control and be monitored by means of computer software. They must be able to withstand adverse weather conditions such as rain, wind over 40 knots, and have an obstacle detector, being able to move at a speed of about 100 km/h, with a durability of 60 minutes of autonomy, as well as quick-charging batteries, maintaining a low noise level, and being capable of carrying parcels of different sizes and a maximum weight of up to 18 kilos.

Furthermore, also preferably, said vehicles must be equipped with parachutes for emergency situations. In the same way, they must have a system of floats in the lower portion that can be immediately inflated upon colliding with an obstacle, cushioning the possible fall, and preventing further damage upon impact.

Moreover, they can also be equipped with analysis software, which makes it possible to plan the most optimal route, enabling the flight to be fully scheduled. However, they can also be controlled by qualified personnel who can control their path and verify the correct operation of the system.

### BRIEF DESCRIPTION OF THE DRAWINGS

The terms Fig., Figs., Figure, and Figures are used interchangeably in the specification to refer to the corresponding figures in the drawings.

With the intention of helping to better understand the system developed and in relation to a practical and preferred exemplary embodiment thereof, a series of drawings is offered where the following has been represented:

FIG. 1 shows a perspective view of an electronic mailbox, with the first door closed, wherein the rigid structure, the visual code on an external surface of the first door and on a lateral wall of said structure, as well as a photovoltaic solar collection panel can be observed.

FIG. 2 shows a perspective view of an aerial vehicle depositing or delivering a parcel in an internal cavity of a mailbox, the first door of which is open.

FIG. 3A shows a perspective view similar to that shown in FIG. 2, wherein the mailbox comprises a moveable frame comprising the internal cavity, such that the first door is open, enabling the parcel to be collected.

FIG. 3B shows a perspective view of the extraction of the moveable frame with respect to the rigid structure of the mailbox, through a second door, the frame being connected to rolling means sliding along a rail.

FIG. 3C shows a perspective view wherein the moveable frame is extracted from the rigid structure and is moving along a rail, also enabling the components of the movement means consisting of two parallel rails and swivel wheels coupled to said rails to be shown in detail.

FIG. 4A shows a perspective view of a mailbox with a plurality of internal cavities that are accessible through one same plurality of individual third doors, also showing a “drone” depositing a parcel through the only first door of said mailbox.

FIG. 4B shows a diagram of the system for moving parcels inside the internal cavities of the mailbox shown in FIG. 4A.

FIG. 4C shows a perspective view of a user accessing an internal cavity of the mailbox shown in FIG. 4A, wherein a third door is open.

FIG. 5 shows two perspective views, front and rear, of a mailbox that has a plurality of internal cavities, like the one shown in FIG. 4A, which also has a second cavity, located on a rear surface.

FIG. 6 shows a perspective view of a portion of a facade of a building, wherein a series of fixed electronic mailboxes can be seen, rigidly attached to said facade, each of said mailboxes being located next to a corresponding window, also showing a “drone” carrying a parcel in the vicinity of a mailbox that has the first door open.

FIG. 7 shows a perspective view of a portion of a building, wherein several mailboxes arranged on the rooftop or roof and rails or guides arranged along the facade of the building can be seen, which enable the frames to be communicated and moved from the fixed mailboxes on the rooftop to the windows of some of the rooms, and some frames located at different points between the initial and final delivery position. A “drone” transporting a parcel on the rooftop can also be observed.

FIG. 8 shows a perspective view similar to that shown in FIG. 7, wherein the building lacks a rooftop, but comprises a platform wherein the mailboxes are located.

A list of the references used in the figures is provided below:
(1) Mailbox
(2) Aerial vehicle
(3) Parcel
(4) First door
(5) Visual code
(6) Solar panel
(7) Moveable frame
(8) Second door
(9) Movement means
   (91) Rolling elements
   (92) Rail
(10) Internal cavity
(11) Third door
(12) Rigid structure
(13) Building

### DESCRIPTION OF THE INVENTION

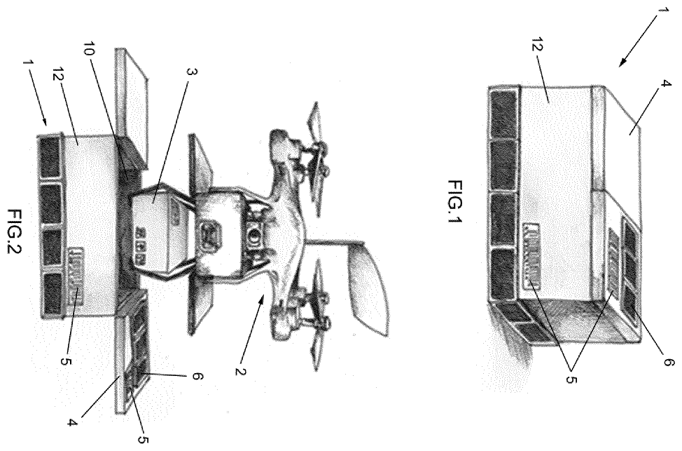

As can be observed in the figures, especially in FIGS. 1 and 2, the invention consists of an electronic mailbox (1) adapted for receiving and retaining parcels (3) so that the operation of said mailbox (1) can be completely automatic and does not require the action of the user for use thereof.

In this way, said mailbox (1) is specially adapted for receiving and delivering parcels (3), by means of a vehicle, which can also be autonomous, especially by means of an aerial vehicle (2), such as a “drone”, i.e., it can also work without being driven or piloted by a user.

Therefore, together with the autonomous mailbox (1) and the aerial vehicle (3), they can comprise a system for collecting and shipping parcels (3) that does not require the presence of any user for the operation thereof.

Moreover, the mailbox (1) can also operate without interacting with an aerial vehicle (2), but rather users are the ones who directly deliver and collect the parcels (3), like an automatic locker.

As can be distinguished from FIG. 1, the mailbox (1) comprises a rigid structure (12) in the shape of a rectangular prism, as well as a first door (4) located on the upper surface of said rigid structure (12), which can be opened and closed by activating electronic opening and closing means, enabling access, or blocking access, to an internal cavity (10) of said mailbox (1), which is adapted for storing a parcel (3). Said means may comprise one or more linear actuators, as well as electromagnets, which enable the opening and closing of the first door (4) in a longitudinally sliding manner, as shown in FIG. 2.

On said first door (4), as well as on one side of the rigid structure (12), the mailbox (1) comprises a visual code (5) in the form of a barcode, which enables said mailbox (1) to be identified by means of image capturing means, provided that said means is located at a greater height than said mailbox (1), at an appropriate distance for correct viewing.

In addition to the visual code (5), FIG. 1 also shows that the mailbox (1) comprises photovoltaic solar panels (6), fixed to the first door (4), which are configured to supply electrical energy to the electrical components of the mailbox (1).

Although they are not visible in the figures, the mailbox (1) also comprises a geolocation device, which enables an external electronic device to detect the position of said mailbox (1), a communication module comprising a receiver and a signal emitter, said module configured to receive and send wireless signals, such as laser, radio frequency, Bluetooth, WIFI signals, or a combination thereof, to other devices comprising communication modules, and an electronic control processor connected to the opening and closing means of the first door (4), to the communication module, as well as to any electronic element of the mailbox (1), enabling said processor to control and manage the operation thereof.

By having these features and elements, the mailbox (1) can work automatically when interacting with the aerial vehicle (2) which can also be automatic, in order to be able to receive and store a parcel (3) without requiring the action of a user. In this way, the operation of the mailbox (1) would consist of receiving, by means of the signal receiver, a wireless signal emitted by a signal emitter of an aerial vehicle (2) carrying a parcel (3), a signal for opening the first door (4).

Once said first door (4) is opened, the aerial vehicle (2) could approach the mailbox (1) and release the parcel (3) in the internal cavity (10), to subsequently move away from the mailbox (1) and perform a new movement, while the first door (4) of the mailbox (1) automatically closes after a scheduled time with respect to the opening of the first door (4), with respect to the collection of the parcel (3), or when the signal receiver of the mailbox (1) receives a first door (4) closing signal.

Once the mailbox (1) has collected the parcel (3), it could send, by means of the signal emitter, a signal to a device controlled by a user indicating that the parcel (3) has been stored in the internal cavity (10), and that the user can collect it when convenient.

To make the delivery and collection of the parcel (3) easy, by means of the mailbox (1) and the aerial vehicle (2), the first door (4) is located on the upper surface of the rigid structure (12), so that the opening created when said first door (4) is opened is a horizontal opening.

In the same way, for the aerial vehicle (2) to approach and position itself with respect to the mailbox (1) as accurately as possible, both devices make use of RTK location technology, which provides centimetre accuracy, which is required for the method described.

Similarly, to enable the aerial vehicle (2) to determine and identify the specific mailbox (1) to which the moved parcel (3) is to be delivered, said aerial vehicle (2) captures, with image capturing means, the visual code (5) of the mailbox (1), such that possible problems of delivery in wrong mailboxes (1) are prevented.

The mailbox (1) can be installed or located in different ways, depending on the needs and characteristics of the user, as well as the available space.

For example, the mailbox (1) can be rigidly fixed to a floor of a sidewalk or a transited space, which the user can easily approach, for example, when a service to a venue or shop is to be provided. In this case, the mailbox (1) would be fixed by a lower surface to the ground, and should have an open flight space to enable access for an aerial vehicle (2).

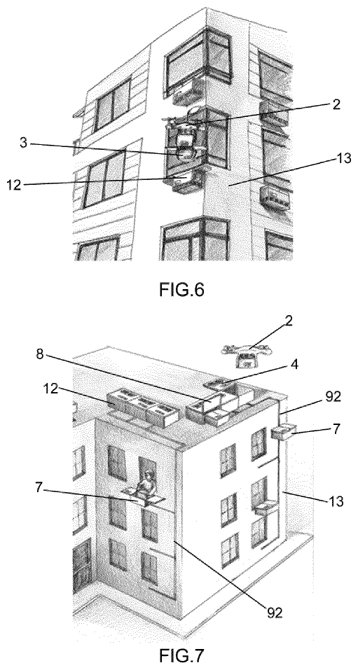

Moreover, if the mailbox (1) is to be given a more personal and private use, without the need to occupy or invade public land, it can be installed on the outside of a building as shown in FIGS. 6 to 8.

For example, in FIG. 6, a facade of a building (13) is shown comprising a plurality of holes in the form of windows, some of which comprise an installed mailbox (1), rigidly fixed at a lower end portion. In this way, when a parcel (3) is deposited by an aerial vehicle (2) in the internal cavity of said mailbox (1), a user can access and collect it, directly from the room where said window is located.

This system enables the mailboxes (1) to be fixed and each room with a window to have an individual mailbox (1).

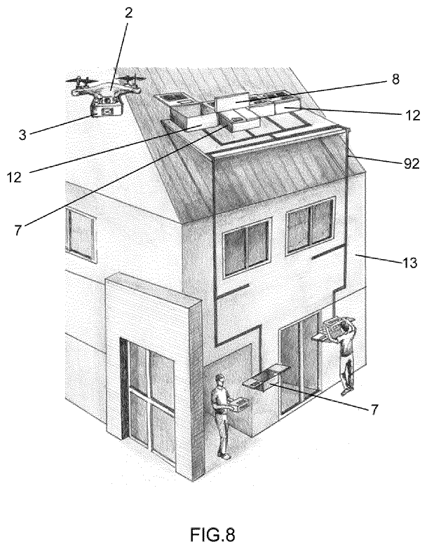

Another way of installing or placing the mailboxes (1) is the one shown in FIGS. 7 and 8, wherein the rigid structure (12) of these mailboxes (1) are respectively installed on the rooftop and on a platform located on the roof of a building (13).

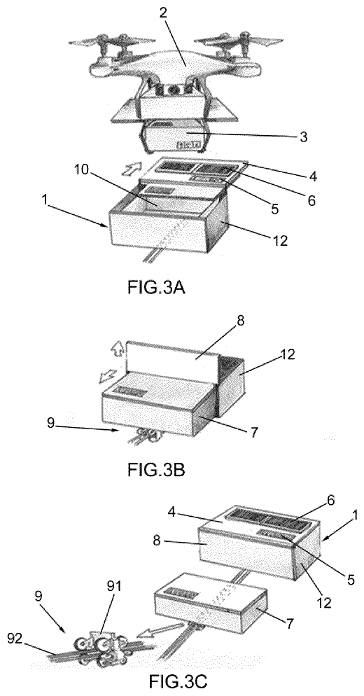

Each of these mailboxes (1) comprises a moveable frame (7) comprising the internal cavity (10) inside the mailbox (1) itself, which can be located inside the rigid structure (12), as well as be moved, by means of movement means (9), shown in FIG. 3C, comprising rolling elements (91) in the form of swivel wheels, and a set of rails (92) located on the facade of a building (13).

With this installation, the operation of the mailbox (1) would consist of, once the parcel (3) has been deposited in the internal cavity (10) and the first door (4) has been closed, and in the same way as the previously defined installation of FIG. 6, extracting the moveable frame (7) with respect to the rigid structure (12), which remains rigidly fixed to the building (13).

Once said moveable frame (7) has been extracted, it can move along the rail (92) arranged on the facade of the building (13) until it is positioned under the window of a user who can access the moveable frame (7) and collect the parcel (3).

These actions are performed when the signal receiver of the mailbox (1) has received an activation signal from the movement means (9), and the control processor thereof has given the command to extract and move said moveable frame (7).

As can be seen in the figures, the moveable frame (7) comprises a prismatic shape similar to that of the rigid structure (12) of the mailbox (1), being of a somewhat smaller size, enabling it to be extracted therefrom through a second door (8), arranged on one side, as shown in FIG. 3B.

This type of installation enables the mailbox (1) to be positioned on a rooftop or on a platform fixed to the roof of a building (13), reducing possible obstacles to the flight of an aerial vehicle (3), so that the rail system (93) enables one same mailbox (1) to be used for several users, without requiring the installation of one mailbox (1) per room, taking advantage of the mobility of the moveable frame (7).

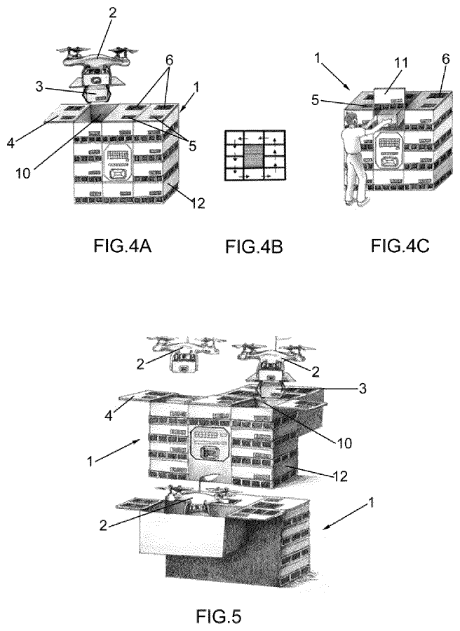

Another type of embodiment and installation of this type of mailboxes (1) is that shown in FIGS. 4A-4C and 5, wherein a mailbox (1) is shown which comprises up to ten internal cavities (10) in the form of a locker, for one same rigid structure (12).

This mailbox (1) comprises, in addition to a single first door (4) for collecting and delivering parcels (3), ten individual third doors (11), arranged on a front surface, for each of the internal cavities (10) of said mailbox (1) such that the storage capacity is multiplied by ten, making it suitable for shared use. In the same way, the mailbox (1) also comprises a movement system that enables the parcels (3) located in said internal cavities (10) to be moved between them, as shown in the diagram of FIG. 4B.

In this way, an aerial vehicle (2) could leave a parcel (3) in an internal cavity (10), through the only first door (4) of the mailbox (1), located on an upper surface, and the movement system could position it in another specific internal cavity (10), until it is collected by a user.

In the same way, this mailbox (1) can also comprise a secondary internal cavity, as shown in FIG. 5, which can operate in a similar way to the previously defined internal cavity, located at a rear portion of the rigid structure (12) which enables parcels (3) or even complete aerial vehicles (2) to be deposited depending on the present needs.

In addition to the mailbox itself (1) and the system comprised by the mailbox (1) and the aerial vehicle (2), the invention also comprises the method for delivering and collecting parcels (3), which has also been defined from the elements comprised in the mailbox (1) itself as well as in the system.

1. An electronic mailbox for receiving parcels comprising a rigid structure wherein said mailbox comprises:
a visual recognition and identification code of the electronic mailbox;
an internal cavity for storing parcels;
a first door of the internal cavity, configured to open and close, by means of electronic opening and closing means;
a communication module comprising a signal receiver, configured to receive wireless signals;
a geolocation device configured to detect the location of the mailbox; and
an electronic control processor connected to the opening and closing means of the first door and to the communication module;
wherein the control processor is configured to activate the electronic opening means of the first door when the signal receiver receives an activation signal.

2. (canceled)

3. (canceled)

4. The electronic mailbox for receiving parcels, according to claim 1, wherein the signal receiver is configured to receive wireless signals selected from laser, radio frequency, Bluetooth, WIFI signals, and a combination of the above.

5. (canceled)

6. The electronic mailbox for receiving parcels, according to claim 1, wherein the communication module comprises a signal emitter configured to emit wireless signals, selected from laser, radio frequency, Bluetooth, WIFI signals, and a combination of the above.

7. The electronic mailbox for receiving parcels, according to claim 1, wherein the geolocation device comprises a location system using RTK technology.

8. The electronic mailbox for receiving parcels, according to claim 1, wherein the rigid structure of the mailbox is fixed, said rigid structure being rigidly attached to an external support; wherein the external support is the facade and/or the rooftop of a building.

9. (canceled)

10. The electronic mailbox for receiving parcels, according to claim 1, wherein the rigid structure of the mailbox is moveable; and the mailbox comprises movement means-connected to said rigid structure, wherein said means are configured to physically move the rigid structure upon being activated.

11. The electronic mailbox for receiving parcels, according to claim 10, wherein the mailbox comprises a moveable frame comprising the internal cavity of the mailbox, and movement means connected to said moveable frame, wherein said means are configured to physically move the moveable frame with respect to the rigid structure of the mailbox upon being activated.

12. The electronic mailbox for receiving parcels, according to claim 11, wherein the mailbox comprises a second door; and wherein the moveable frame is configured to be extracted and inserted into an interior of the rigid, fixed structure, through said second door.

13. The electronic mailbox for receiving parcels, according to claim 11, wherein the movement means comprise at least one rail and rolling elements, connected to the internal cavity, moveable along said rail.

14. The electronic mailbox for receiving parcels, according to claim 11, wherein the electronic control processor is configured to activate the movement means when the signal receiver receives an activation signal of said means.

15. The electronic mailbox for receiving parcels, according to claim 11, wherein the movement means are configured to move the internal cavity of the mailbox along a facade of a building.

16. The electronic mailbox for receiving parcels, according to claim 1, comprising a plurality of individual internal cavities for storing parcels; wherein each cavity comprises a third door for individual access to said internal cavity.

17. The electronic mailbox for receiving parcels, according to claim 16, wherein the mailbox comprises a single first door for access to the plurality of internal cavities comprised in said mailbox; and wherein the plurality of internal cavities are communicated by a movement system configured to move parcels between said plurality of individual cavities.

18. A system for collecting and shipping parcels, comprising at least one autonomous aerial vehicle for delivering and collecting parcels and an electronic mailbox as defined in claim 1.

19. The system for collecting parcels, according to claim 18, wherein the aerial vehicle comprises means for depositing and collecting a parcel from a surface of an internal cavity of the mailbox; and it is configured to move said parcel from a dispatch reception position to an initial delivery position.

20. A method for delivering parcels comprising the steps of:
moving a parcel, by means of a flying vehicle, from a dispatch reception position to an initial delivery position; and
depositing the parcel, by means of the flying vehicle, in an internal cavity of a mailbox as defined in claim 1, said mailbox being located in the initial delivery position.

21. The method for delivering parcels, according to claim 20, wherein the step of moving a parcel comprises the steps of:
locating the initial delivery position of the mailbox, by means of the aerial vehicle, using an RTK geolocation system;
reading, by means of an image capturing device comprised in the aerial vehicle, the visual recognition and identification code of the mailbox, said code being located on a surface visible from a position of a greater height of said mailbox;
sending a wireless signal, by means of a signal emitter located in the aerial vehicle, to the signal receiver of the communication module of the mailbox, for activating the electronic opening and closing means of the first door; and
opening the first door of the internal cavity by means of the electronic opening and closing means.

22. The method for delivering parcels, according to claim 20, comprising the steps of:
automatically closing the first door of the internal cavity by means of the electronic opening and closing means; and
sending a wireless signal of parcel deposition in the internal cavity, by means of a signal emitter located in a communication module of the mailbox, to a receiving device of an electronic device;
wherein said steps are subsequent to the step of depositing the parcel, by means of the flying vehicle, in the internal cavity.

23. The method for delivering parcels, according to claim 21, comprising the steps of:
moving the internal cavity of the mailbox wherein the parcel is located, by means of the movement means, from the initial parcel delivery position to a final delivery position;
collecting the parcel, by means of a user, from the internal cavity of the mailbox, in the final delivery position; and
moving the internal cavity of the mailbox, by means of the movement means, from the final parcel delivery position to an initial delivery position.

24. The method for delivering parcels, according to claim 20, comprising the step of:
moving the parcel deposited in an internal cavity of the mailbox, to another internal cavity of the plurality of internal cavities comprised in the same mailbox, by means of the movement system;
collecting the parcel, by means of a user, from the internal cavity of the mailbox that houses the parcel, by opening the third door for individual access to said internal cavity.
